(19) United States
(12) Patent Application Publication
(10) Pub. No.: US 2022/0319261 A1
(43) Pub. Date: Oct. 6, 2022

(54) Automatic Door Opening Systems and Methodolgies

(71) Applicant: Dylan Dabel, Sunnyvale, CA (US)

(72) Inventor: Dylan Dabel, Sunnyvale, CA (US)

(21) Appl. No.: 17/221,793

(22) Filed: Apr. 3, 2021

(51) Int. Cl. G07C 9/00; E05F 15/70; G08B 13/08; G10L 25/51; G10L 17/22; H04N 7/18; G06K 9/00

(52) U.S. Cl. CPC G07C 9/00904; E05F 15/70; G08B 13/08; G10L 25/51; G10L 17/22; H04N 7/188; G06K 9/00926; G06K 9/00013; G06K 9/00087; H04N 7/181; G07C 9/00714; E05B 63/0017

(57) ABSTRACT

The Intelligent Door Opening system consists of several devices that work together to identify approaching individuals, verify that they should be allowed access, which can be conducted by several different means. Once they have been approved the system will then grant them access by opening the door and then closing said door when the individual has entered the building. The Intelligent Door Opening system will also comprise several devices to add additional security to the primaries home, examples being a deadbolt that stops hackers from being able to control the other devices, a camera, and a secure locking system. The intelligent Door Opening system will add all the convenience of an automatic door as seen at a mall, but with the security to ensure that only people that are allowed access will be allowed to enter.

### FIELD OF THE INVENTION

The invention relates generally to securely opening/closing doors. More particularly, the invention relates to systems and methods for securely granting access, based on a plurally of possible means to determine permission, then allowing access by opening, then shutting the door automatically.

### BACKGROUND OF THE INVENTION

Doors since their invention have required some sort of effort to lock, unlock and open. People have been stuck outside their house because they forgot the keys, stressed about leaving their door open or unlocked, or been stuck struggling outside while they try to get their keys out of their pocket and unlock the door with three bags of groceries in their arms.

Doors at grocery stores have been fitted with motion sensors, or heat sensors but this allows every living thing that triggers the sensors to enter the store.

Utilizing the present invention enhances home and business owners' lives by giving them the ability to never have to stress about these problems anymore. Never again will they be stuck trying to get their door open or have to worry about it being left open. With this invention the primary user will be able to have a sense of ease and comfort for their home knowing that their door and home are more secure and they will have the luxury of never having to struggle to open the door again. While there have been inventions in the past that open doors using sensors like motion sensor doors at stores or doors that require a button to be pressed to assist handicapped people. All of these previous options did not have the security that will be allowed by the Intelligent Door opening system.

### SUMMARY OF THE INVENTION

The Automatic Door Opening system is comprised of a smart lock, a smart device that operates as a doorknob or door handle, a camera that is able to identify people that are allowed access, a means of approving or deny access, a deadbolt that can block other devices from receiving other signals, a device with the means to open and close the door, a app that can be used for multiple different purposes, speakers to relay audio, a microphone to pick up audio, a device that can receive and recognize tapped out patterns, and the ability to recognize phones and open the door for approaching approved people.

The Automatic Door Opening system identifies approaching people either from wireless signals from their phone, by their face when captured by the camera, with preset tapped out patterns, preset audio phrases, scanned fingerprints, or a preset code being entered into a keypad. In use, the Automatic Door opening system recognizes an approaching person on the camera, identifies the approaching person, and then will either approve or deny their access and if approved the door is then opened so as to allow unimpeded access to the building. The same secure opening for authorized user only is accomplished when the Automatic Door Opening system recognizes a phones signal and allows access to the individual who is approaching. The Automatic Door Opening system brings ease of use and luxury, and security to houses and other buildings.

### BRIEF DESCRIPTION OF FIGURES

FIG. 1. illustrates where the multiple component devices for the ADO system are installed in reference to the door.

FIG. 2. illustrates a plurality of alternate locations where cameras can be placed on the building where the ADO is installed.

FIG. 3. illustrates a camera for the ADO system capturing the surroundings and the individuals in its field of view.

FIG. 4. illustrates a situation where an approved user (the primary user) approaches the door and the ADO validates the user as authorized and then opens the door responsive to the connection between the ADO system and the approved individual's phone.

FIG. 5. illustrates how images captured by the camera (6) are used by the ADO system to validate the user as authorized and then opens the door to allow access to the building.

FIG. 6. illustrates the ADO system sounding an alert in the house to give notice that the door is opening.

FIG. 7. illustrates an alarm being sounded when it is triggered by someone trying to hack the ADO system or trying to force the door open.

FIG. 8. illustrates the ADO system recognizing a voice or vocal phrase and then validates if the user is authorized and then opens the door for an authorized user.

FIG. 9. illustrates an alert being sounded, and a notification being sent to a primary user's smartphone when the doorbell is pressed or when an authorized user is granted entry, or when someone is trying to hack the ADO system or trying to force the door open.

FIG. 10. illustrates some of the options for interacting with the ADO, and shows the case where when an approved individual has a photo linked to their account which causes the ADO to allow that authorized user to be permitted access responsive to their image being captured by (the camera.

FIG. 11. illustrates a case when a deadbolt is engaged so that the ADO system can not open the door and can further inhibit the ADO from receiving any commands.

FIG. 12. illustrates ADO devices fit with battery packs and lights to indicate when the batteries need to be replaced.

FIG. 13. illustrates a primary user sending audio messages to the ADO from their phone that responsive to the ADO are played out of the built in speaker.

FIG. 14. illustrates a primary user opening the door utilizing their cellphone to communicate with the ADO system.

FIG. 15. illustrates the ADO issuing an alert sent to the primary user's cellphone responsive to detecting an attempted forced entry/hack.

FIG. 16. illustrates an optional keypad device that can be added as another option to allow access.

FIG. 17. illustrates an optional fingerprint scanner that is added to the ADO to be used as another means to achieve access to the building through the ADO system.

FIG. 18. illustrates a primary user updating the ADO system with data for additional authorized users.

FIG. 19. illustrates the ADO system recognizing a tapped out pattern which is sent to the ADO system to be recognized if authorized to grant access to the building.

FIG. 20. illustrates a situation when the ADO, responsive to a sensor, realizes that the door was left open and then proceeds to activate closing of the door.

FIG. 21. illustrates sensors attached to the cameras and the sensors detecting an individual entering the camera's field of view to activate the ADO system.

### DETAILED DESCRIPTION

As technology advances people expect their lives to become easier and easier. We have all had the problem of approaching our front door and not being able to open it whether it be due to holding too many groceries, losing keys, or whatever may be hindering a person. The present ADO methodology and system is able to detect incoming individuals, authorize approved individuals, and then allow entry into a house or other building, thereby providing ease and security that has not previously been available.

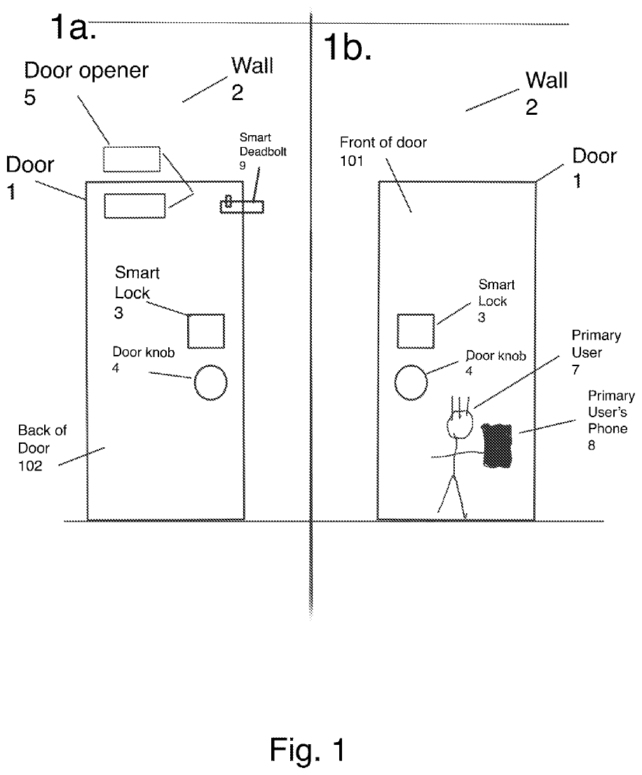

FIG. 1 is a diagram of one embodiment of devices that make up the Automatic Door Opening [“ADO” ] System. On the left (1a) shows the back of the door that the Automatic Door Opening system (3) is installed on and on the right (1b) shows the front of the door. There is a wall of the building that is supporting the door that the Automatic Door Opening System is installed on.

The ADO (3) is comprised of a system that operates as a smart lock that begins the process of opening of the door (4), utilizing a device that can also function as a door knob/handle (5), and a device that once the door has been unlocked can be used to move the door to an open position and then to close the door, and is further comprised of a deadbolt (9), that secures the door from being opened and can also be used to remotely block any device including the ADO components from receiving signals when the deadbolt is engaged and locked, thus ensuring the door remains closed when the primary user wants the extra security. This deadbolt is a lock that will only be able to be engaged by manual means. This adds a layer of security that is not usually seen in smart locks. When the Primary user has engaged this deadbolt lock it sends a signal to devices (3,4, and 5) disabling them so the door cannot be accessed through the automatic door opening system or through physical means. These and other aspects of the present invention will be further described hereinafter and illustrated in the figures herein.

The smart lock that functions as the part of the Automatic Door Opening system that begins the door opening process. The smart lock is responsible for the unlocking and locking of the door. The smart lock device knows when to open the door when an approved user is authorized by the ADO or when an authorized user's authorized phone comes within a certain distance, and the smart lock receives a signal from a computer system that communicates that an approved person has been verified by the cameras, or other means to authorize entry.

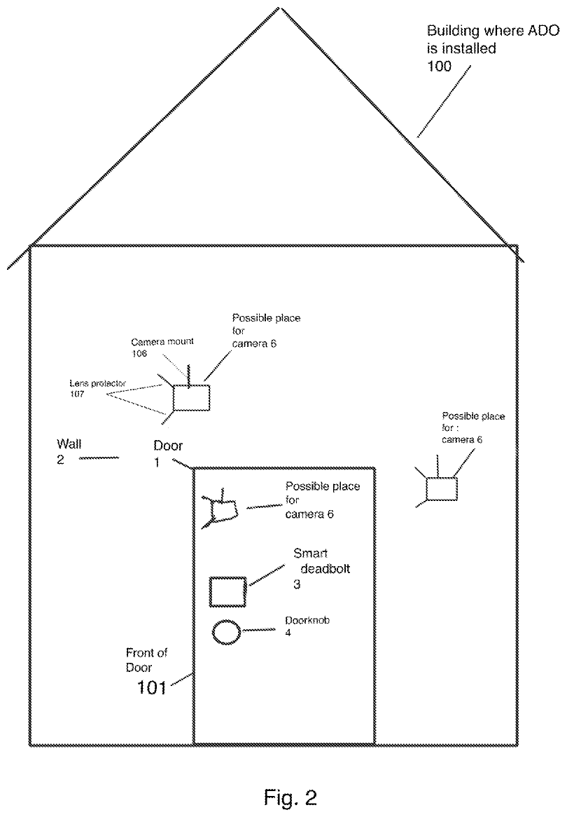

FIG. 2 illustrates multiple alternative positions where cameras could be placed on the primary user's house/building or door. With one or more of cameras, it allows for multiple images to be taken of all approaching individuals (18) at different angles, ensuring that a better chance to recognize any possible incoming user as an approved user if proper to do so (or not approved).

A camera can either be wired to the house or use battery power and wirelessly communicate. This camera has a field of view that is able to fully capture the area approaching the door of the building making sure that all approaching individuals are able to be sensed. When an individual approaches the door, the camera captures an data for an image of the person's face and sends that data for the image so that the ADO can determine if the person should be allowed access to the building or not. This means of determining whether or not a person should be granted access (18) can use facial recognition, neural net, or other similar methods to approve or deny an individual's access.

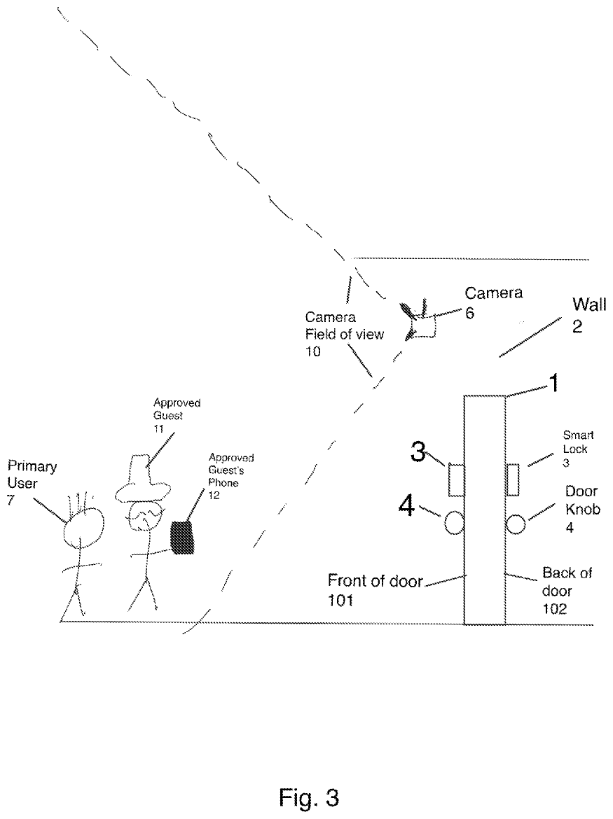

FIG. 3 illustrates the camera's field of view, which is what is captured when the camera is recording. The field of view also refers to the range within which sensors detect motion, thermal energy, or other disturbances that can trigger the appropriate sensor to activate. When a primary user, or another approved guest enters the sensor or camera's field of view, it triggers the camera(s)/sensor(s) to activate. This in turn helps to ensure that there is a highest chance that the approaching individuals will be recognizable from the data/footage captured by the camera(s)/sensor(s) when the data is sent to the ADO (18). (18) is the computer system that will help the ADO system function and will be discussed later in the patent.

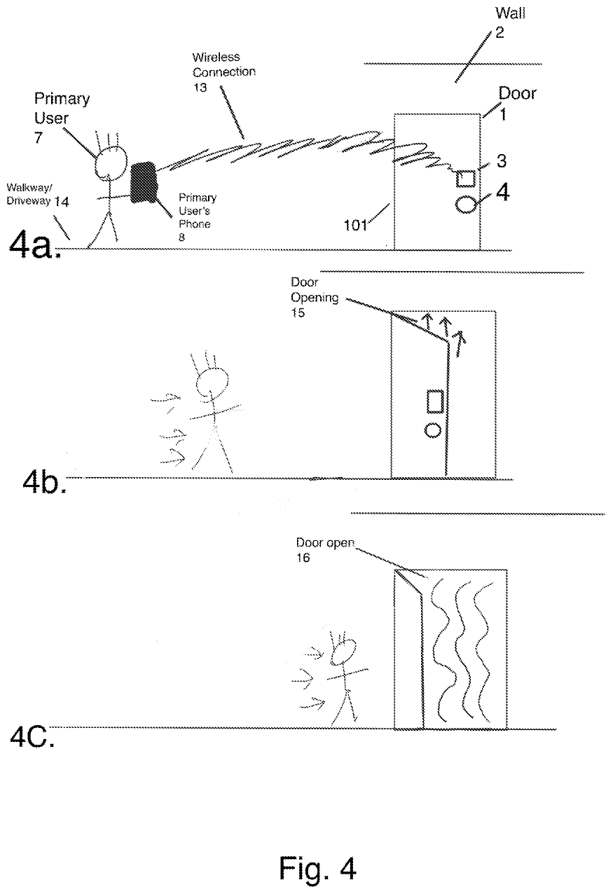

FIG. 4 illustrates the process where when the primary user approaches the door and they get in range of the sensor/camera, the Automatic Door Opening system (ADO) senses the signal from the primary user's smartphone. The primary user of the door opener system has more options than other approved users. The primary user's telephone is connected to the door opening system through WiFi, Bluetooth, Zigway, or any other means of wireless connection. The owner's phone [or other users' approved phones], is one of the ways a person can access the building where the ADO is installed. When the person with an approved phone enters a certain distance from the door, the ADO detects the person's phone via a bluetooth/wifi bridge as is described in more detail hereinafter.

At 4a., it shows the primary user (7) approaching the door with their phone (8). As the primary user approaches the door, the signal from the phone is received (3). The signal is able to be detected due to a Wifi/Bluetooth bridge that is able to detect the approaching individual's phone. At 4b., it shows (15) the process of the door opening once the process has begun. The door opens at a speed to allow the primary user to enter the building without being stopped. At 4c., it illustrates the primary user about to enter the open door.

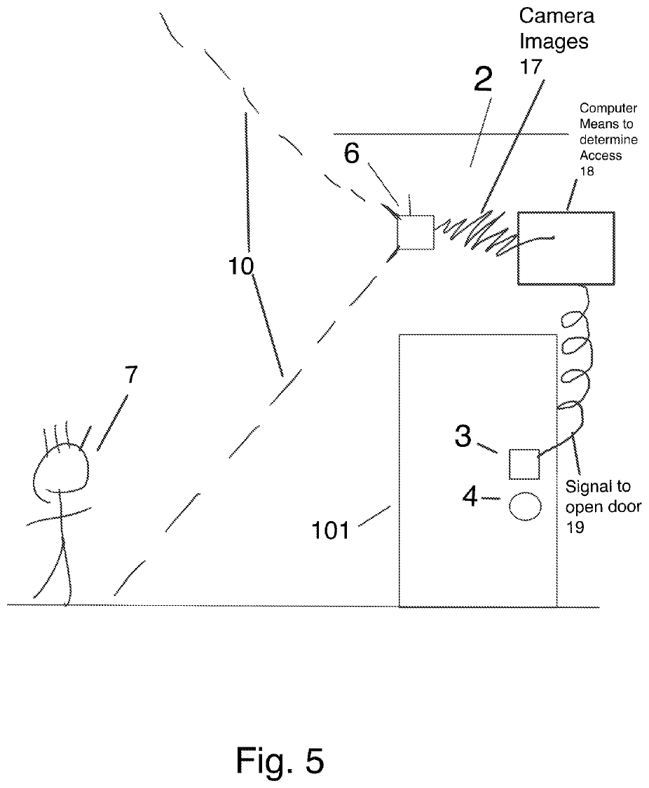

FIG. 5 illustrates when the primary user or other approved user is identified by the ADO responsive to input data from the camera/sensor. This process begins when the individual enters the sensor/camera's field of view (10). Once the cameras have started to capture data from the sensor/camera such as of the images of the individual they send the data for the captured images wirelessly (17) to a means of determining if the individual is an approved user (18). Once the means of determining if the individual is an approved user (18) has determined that the individual is the primary user or a different approved user, an authorization signal (19) is sent to (3) to start the door opening process.

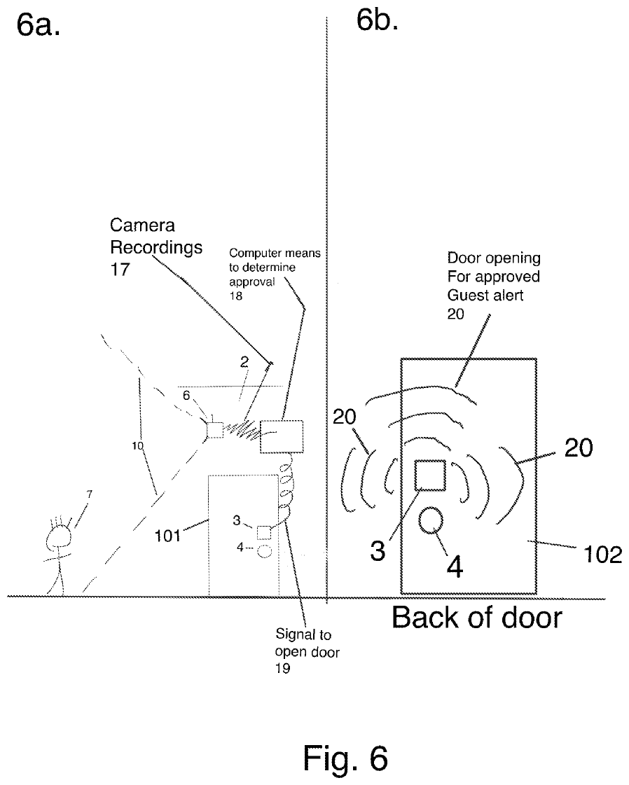

FIG. 6 Starts at 6a., shows the primary user (7) being approved for entry by (18). At 6b., (3) plays a tone (20) that is used to inform people on the inside of the house that the door is about to open before (5) actuals begins the process of opening the door.

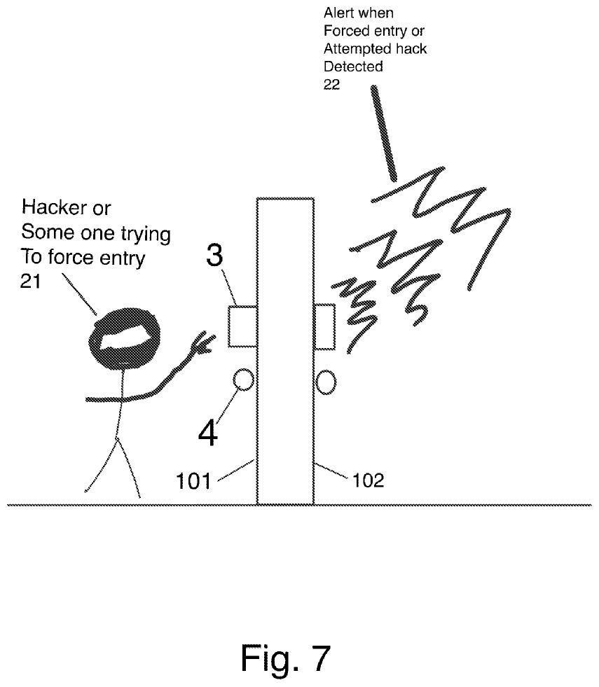

FIG. 7 illustrates that when someone (21) is trying to break into the house by either hacking the ADO or trying to force entry, and responsive to detecting this, the Automatic Door Opening system sounds a loud, aggressive alert (22) through the inside of the house.

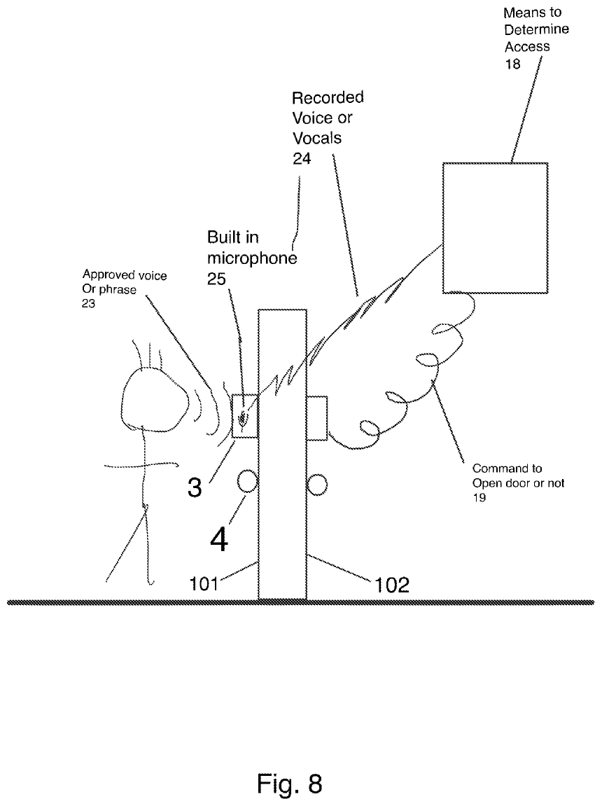

FIG. 8 illustrates when an approved person, states a preset phrase or otherwise uses their voice so that it can be recognized (23). Once the microphone (25) records the spoken audio, the audio is sent to the (18) to determine if this is an authorized user (where the correct phrase was said, or if the voice matches one of the approved users). If the recording matches either criteria then a signal (19) is sent to (3) which begins the door opening process.

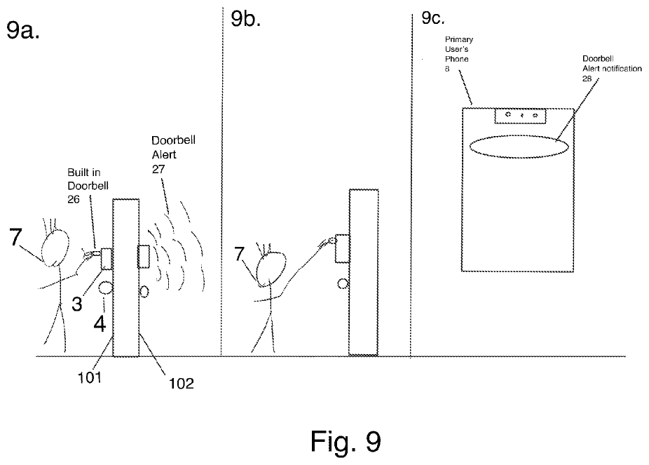

FIG. 9 illustrates a person pressing the doorbell (26). Once the doorbell is pressed a specific tone (27) is played through the inside of the house. This tone will be different from other tones, so as to inform people inside the house that someone is outside that needs access to the house or may need to speak to the people inside. Once the doorbell is pressed an alert (28) can also sent to the primary user's phone. At 9a., the individual pressing the doorbell generates an alert (27) going off inside the house. At 9b., the person is still doing the original action of pressing the doorbell, but at 9c., an alert is been sent to the primary user's phone.

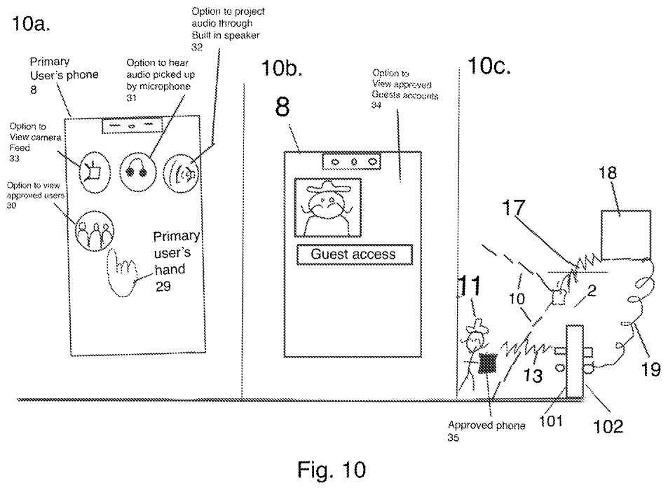

FIG. 10 at 10a., illustrates a view of the primary users phone with a simplified version of the application connecting the phone to the ADO system to open the door. Through the app, accounts can be made, such as the primary user's account. Accounts can be made for temporary guests or long term accounts for other residents of the building. Accounts connect the user's phone to the automatic door opening system through Bluetooth, WiFi, Zigway, or another means of wireless connection. Accounts can also provide a photo or several photos that can be used with a neural net, facial recognition, or another means to approve the person's entry from the footage recovered by the camera. The application, also provides options to hear audio (31) that is being picked up by the microphone (25), project audio (32) through the built in speakers (41), view the live camera feed (33), and an option to view approved users profiles (30) as selected by the primary user's (29) hand. At 10b., it illustrates a next page in the application after the user profiles option is selected., showing the option to add images (34) for a new approved user's profile. Adding these images of the approved user will help them be recognized by (18) when (6) provides data (records) them approaching the door. At 10c., it illustrates the approved guest being sensed, which guest recently had their images added to the account, being recognized as an authorized user by (18), which grants that user access to the building.

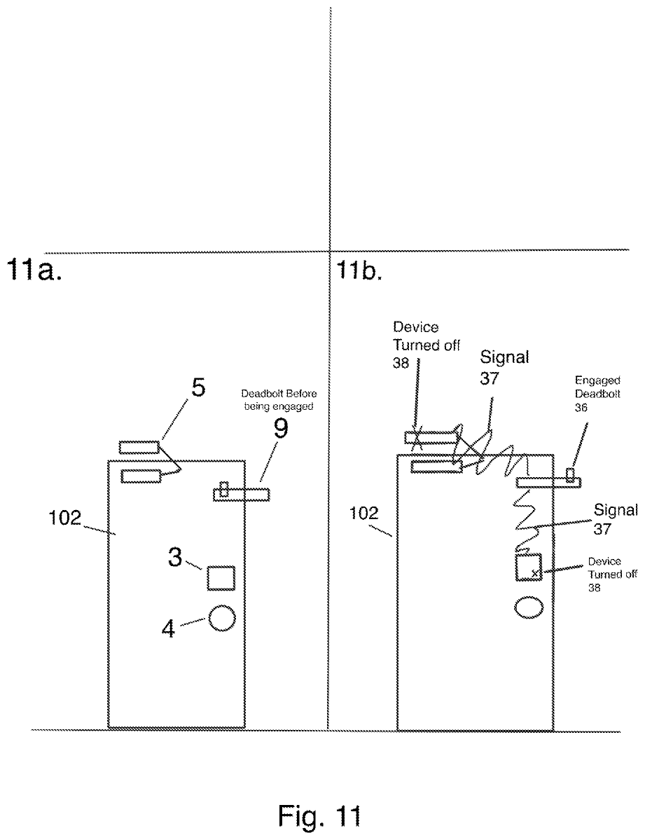

FIG. 11 at 11a. shows the back side of the door after (9) has been engaged. This shows (9) as a physical means to stop entry to the building. At 11b. it illustrates when (9) is engaged and signals (37) are sent to (3, 4, and 5) which then effectively turns these devices off so they can not receive any commands while (9) is engaged.

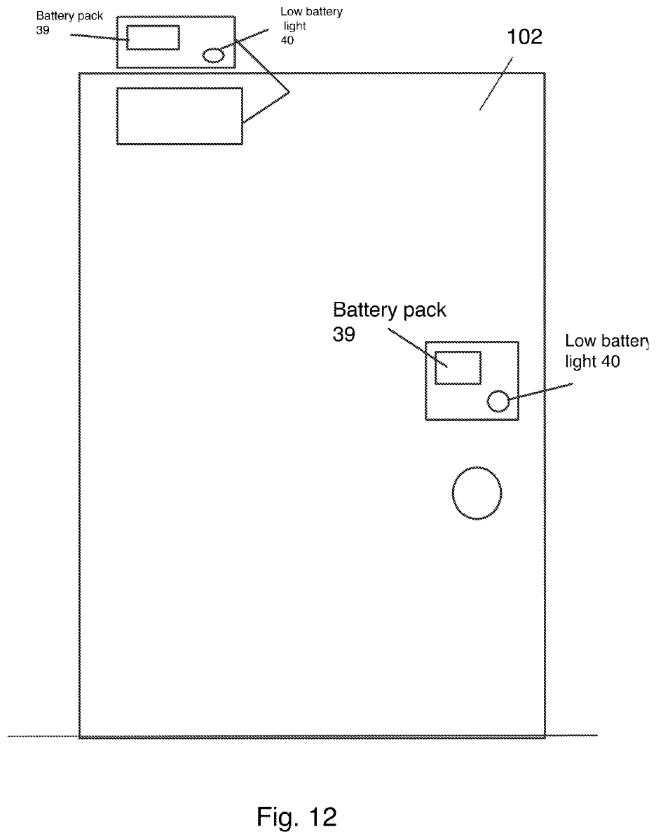

FIG. 12 illustrates where devices of the ADO are fitted with battery packs (39) and lights that indicate when the battery in each device is getting low (40). These lights provide an effective tool to help the primary user make sure that the ADO system functions properly and that no problems arise due to one or more devices having insufficient battery power.

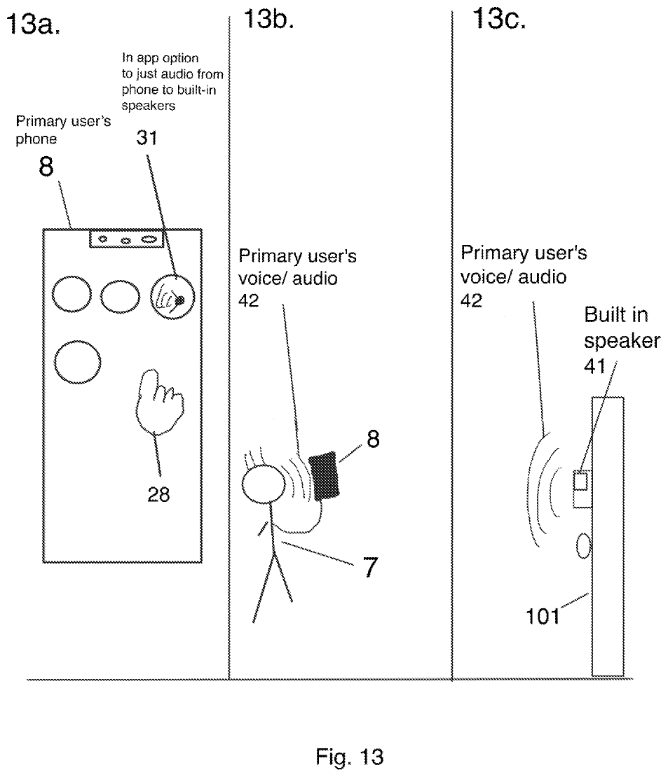

FIG. 13 illustrates where the primary user utilizes their smartphone to communicate or play audio out of the speaker to the outside of the house. In this situation, the primary user (7), speaks into their phone or plays audio (42). The audio (42) is then played out of the built in speakers (41). This process is shown at 13a., where the primary user selects the option in the application (31) to play audio out of the built in speakers (41) that are part of (3). At 13b., the primary user is shown speaking the audio into their smartphone, which audio is then played through the built in speakers at 13c.

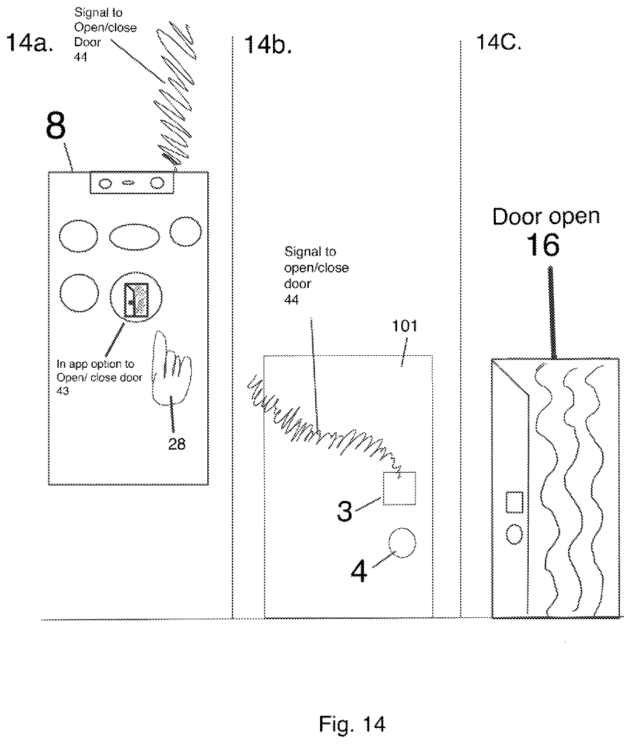

FIG. 14 illustrates how the primary user can use their phone (8) through the application to open and close the door. A signal from an authorized phone tells the Automatic Door Opening system that someone is approaching that is approved for entrance and that the door should open. This signal is sent from the phone and received by the ADO. The receiver will be located inside on device (3).

When the primary user presses the option to open/close the door (43), a signal (44) is sent to 3, which starts the door opening. At 14a., it illustrates the primary user choosing the in application option to open [and/or] close the door (43). At 14b., it illustrates a signal (44) being received by (3) that was sent from the primary user's phone when the option was clicked to open the door. At 14c., it illustrates the door open after the signal was received and the door opening process was complete.

When a person is at the door and does not have their phone and the camera was not able to approve their face [such as due to mask, hat, or another possible issue], the approved user has the option of approaching device (3) which will have a built-in microphone and say a preset phrase that allows them access. After the person who is requesting access has said the phrase the recording is sent to a means of determining if the phrase is the correct one to allow access to the building. Once the means of determining if the phrase is the correct receives the recorded phrase it analyzes it to determine if it should approve access. The system determines if the phrase or person's voice should be approved (18). After the test has been run, and if the phrase has been approved, a signal is sent back to the automatic door opener to inform the system to open the door.

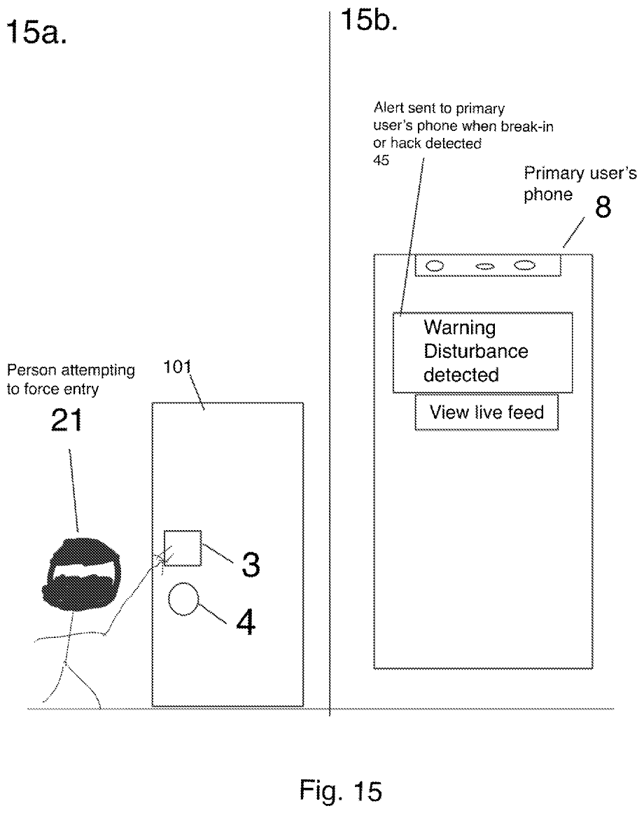

FIG. 15 illustrates when someone is trying to break into the house by either hacking the ADO or trying to force entry, where responsive to so detecting, the Automatic Door Opening system sends an Alert (45) to the primary user's phone and allow them to see a live feed from the camera.

At 15a., it illustrates the hacker/burglar attempting to force entry into the house either by hacking the ADO system, picking the lock, or forcing entry. When these attempts are sensed by the ADO, an alert is sent to the primary users phone as shown at 15b.

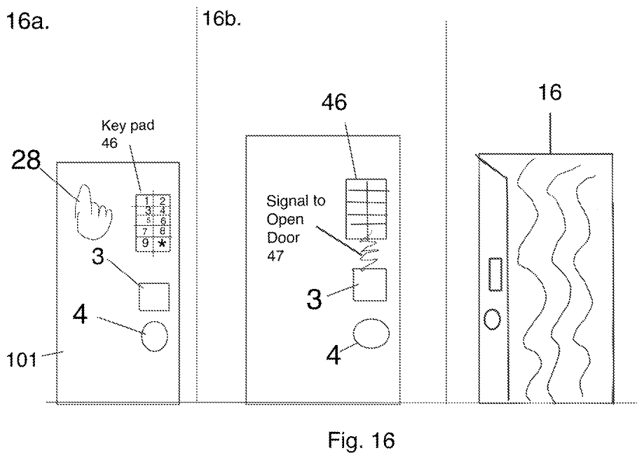

FIG. 16 illustrates the keypad (46) providing an option that the primary user can choose to include. When a preset code is properly entered into the keypad it sends a signal (47) to (3) which in turn begins to open the door. At 16a., it illustrates the primary user typing in the correct code to the keypad. At 16b., it illustrates that once the correct code is entered into the keypad, that a signal is sent to (3) which after receiving the signal begins opening the door which is shown fully opened at 16c.

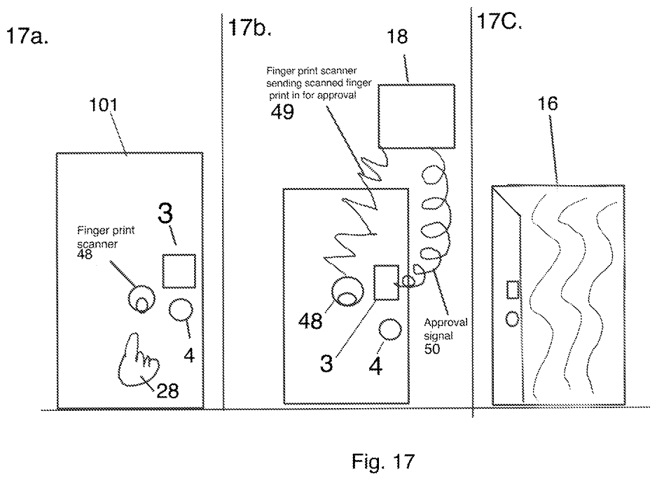

FIG. 17 illustrates a fingerprint scanner (48) and how works relating to the Automatic Door Opener. Once a fingerprint is scanned, the data for the scan is sent to (18) to determine. if the fingerprint is recognized as an authorized user, and if it is then a signal (50) is sent to (3) which starts the door opening process. At 17a., it illustrates the primary user scanning their finger. Once the fingerprint is scanned, the data for the scanned print is sent to (18) which authenticates the data for the print. If the fingerprint is approved by (18) a signal is sent to (3) which starts the door opening process, as shown at 17b. The fully is shown as opened door at 17c.

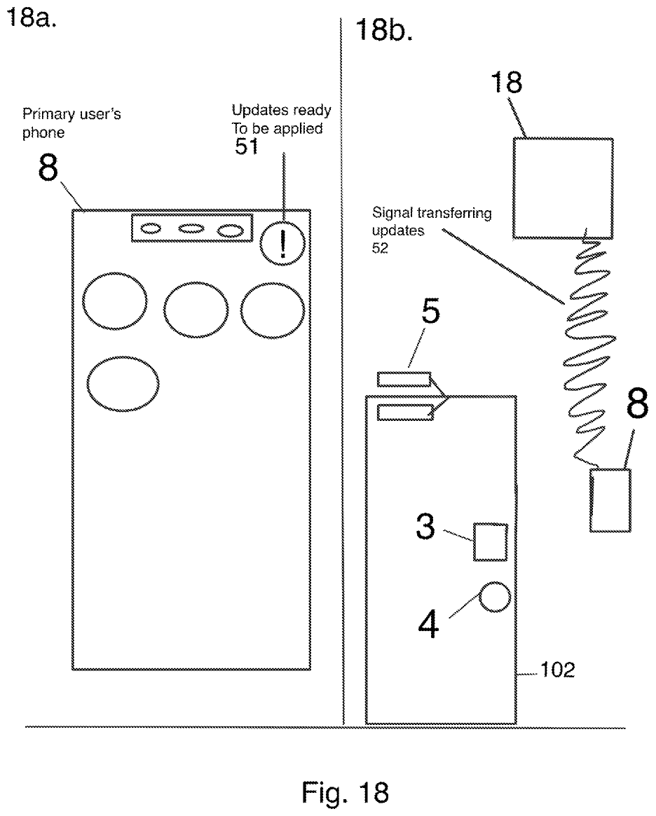

FIG. 18 at 18a. illustrates where there are available updates (51) for the ADO. The primary user is alerted through the application when updates are available, and when the primary user chooses to do so they can begin the process of updating the ADO by sending the updates from their phone to (18). The system of 18 provides software that runs the ADO system. The software can run on a computer in the house, on the primary users phone, or even on a smart one of the attached devices. The updates are sent to (18) through a wireless signal (52). At 18b., it illustrates the updates being sent wirelessly to (18) so as to thereafter make sure all the devices do their jobs smoothly.

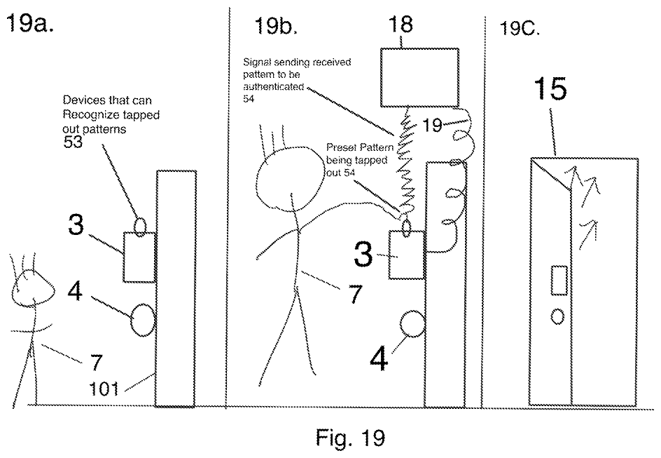

FIG. 19 illustrates a device (53) connected to (3). This device (53) detects physical contact and is able to recognize tapped out patterns. When an individual approaches the device and taps out a correct preset pattern (54), the device (53) receives the tapped out pattern and sends data for what it received to (18) if the pattern is correctly tapped out so that an authorization signal is sent to (3) to the devices to allow access. At 19a., it illustrates the primary user approaching the door. Once they have reached the door, at 19b. they proceed to tap out a preset code (54) on device (53). The data for the code is then sent to (18) where it is approved and then a signal is sent to (3). After the signal is received the door is opened as shown at 19c.

The automatic door opener system can also include either a built-in doorbell that is connected (3) or a separate device that functions like a doorbell that can be placed wherever the primary user chooses. When the button is pushed an alert is sounded from the built-in speaker that is part of the inside section of device (3). This tone will be a unique tone that device (3) plays inside the house to inform people that someone is attempting to access the building or communicate with the people inside. When the button is pressed an alert can also sent to the primary user's phone via the app. This option can be turned off through preferences on the app or the notifications can be muted if the primary user chooses to do so.

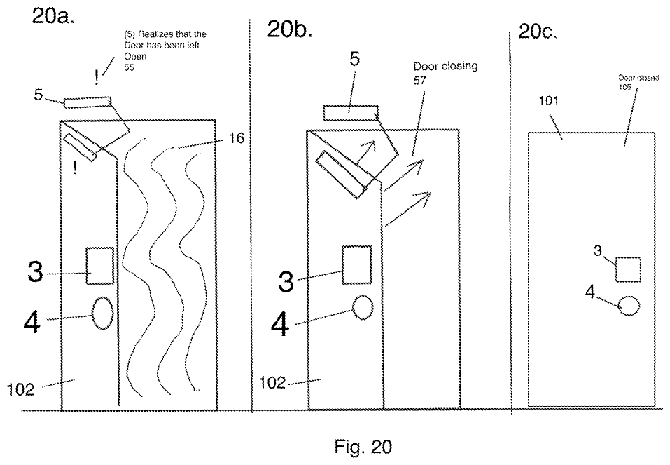

FIG. 20 illustrates when the door to the building is left open (55). In this Situation, the ADO recognizes that the door was left in an open position for a set amount of time as shown at 20a. Then, responsive to recognizing this, as shown at 20b., the device (5) begins to close the door (57), and as shown at 20c. the door is fully closed.

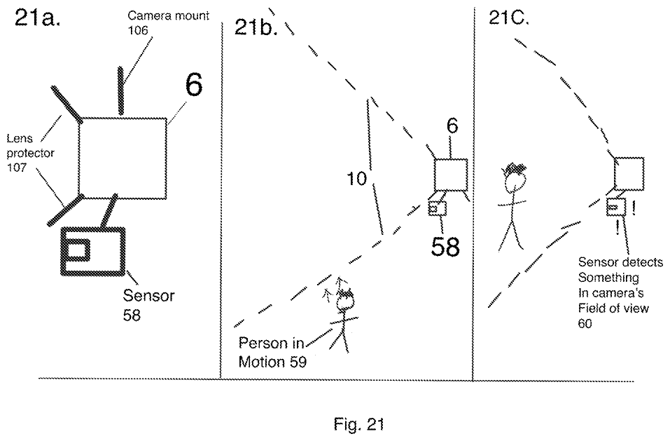

FIG. 21 illustrates a sensor (58) that is able to detect motion, thermal energy, or several other types of disturbances. The sensor can be independent or fitted to one or all the cameras that the primary chooses to put around the building. When the sensor picks up any of the disturbances that it is able to detect [like a person in motion entering the camera's field of view] the sensor will turn the camera on and begin the recording process. As shown at 21a., the sensor (58) is attached to the camera(s) (6). As shown at 21b., an individual in motion is about to enter the camera and sensor's field of view. As shown at 21c., the individual triggers the sensor which in turn starts the camera recording.

When moments are captured by the camera picking up motion and recording it, these moments are sent as clips to the app on the primary user's phone. These clips are able to be viewed later if the primary user chooses to do so. Also, the primary user can connect to the cameras through the app using Bluetooth, wifi or another means of wireless connection. Once connected through the app the primary user can watch a live feed of the camera's field of view.

These aspects of the present invention are set forth in the appended claims hereafter.

1. A system for automating security and entry into a locked building, comprising:
means for detecting an incoming individual to create user input data;
an authorized individual database storing entrant data therein for individuals that are authorized users authorized for entry into the building;
means for comparing the user input data for the image of the incoming individual to the entrant data in the authorized individual database and providing an authorized signal if the incoming individual is recognized as one of the authorized users in the authorized individual database;
means for activating a lock release to unlock an entry into the building responsive to the authorized signal, to permit entry into the building by the incoming individual that was recognized as one of the authorized users.

2. The system for automating security and entry as in claim 1,
wherein there is from one to multiple cameras used to capture an image of the entrant to generate the entrant data for said individual for comparison to the authorized individual database.

3. The system for automating security and entry as in claim 2,
wherein the cameras are fitted with a sensor that will be able to detect at least one of motion, thermal energy, and sound disturbances,
wherein the camera is activated when the disturbance is detected.

4. The system for automating security and entry as in claim 1,
wherein one of the individuals authorized for entry is a primary user having a primary users account that defines which individuals are authorized for entry;
the system further comprising:
means for adding new user input data to the primary user's account, for a new approved user as an individual that is an authorized user that is authorized for entry that will thereafter be able to use the system to provide approval for entry and will provide for opening of the door.

5. The system for automating security and entry as in claim 1,
wherein the authorized individual database also contains fingerprints for at least some of the authorized users,
wherein the system is further comprised of a fingerprint scanner for scanning the fingerprint of said incoming individual, and,
wherein the scanned fingerprint of the incoming individual is compared to the entrant data in the authorized individual database to see if the fingerprint is recognized, and if it is then a signal is sent to open the door.

6. The system for automating security and entry as in claim 1,
wherein the system for automating security and entry is fitted with a keypad for entering a user input code by said incoming individual,
wherein there are authorized preset codes for at least some of the authorized users, and wherein the user input code of the incoming individual is compared to the authorized preset codes to see if the user input code is recognized, and if it is then a signal is sent to open the door.

7. The system for automating security and entry as in claim 1,
wherein a tone is played when said incoming individual is approved for entry as an alert that the door is opening.

8. The system for automating security and entry as in claim 1,
wherein a loud, aggressive alert tone is played when there is one of an attempt at unauthorized opening of the door and actual forceful unauthorized opening of the door.

9. The system for automating security and entry as in claim 1,
wherein at least one person is a primary user with a phone,
wherein the system sends an alert to the primary user's phone when there is one of an attempt at unauthorized opening of the door and actual forceful unauthorized opening of the door.

10. The system for automating security and entry as in claim 1,
wherein the system is backed up with power from battery packs that have lights to indicate when the power of the battery is getting close to empty.

11. The system for automating security and entry as in claim 1,
wherein the authorized database also contains authorized voice samples for at least some of the authorized users, and
wherein the system for automating security and entry is fitted with a microphone for sensing voice sound spoken by said incoming individual,
wherein the user voice sensed of the incoming individual is compared to the authorized voice samples in the authorized individual database to see if the user voice sensed of the incoming individual is recognized, and if it is then a signal is sent to open the door.

12. The system for automating security and entry as in claim 1, further comprising a deadbolt that when engaged adds a physical lock to the door, and ensures that the door cannot be opened by the system.

13. The system for automating security and entry as in claim 1, further comprising:
a speaker outside the door,
wherein the system provides means for the primary user to utilize a phone to communicate audio out of the speaker.

14. The system for automating security and entry as in claim 1, further comprising:
means for sensing that the door has been left open beyond a defined time limit, and responsive thereto, providing for closing of the door.

15. A method for automating security and entry into a locked building, comprising:
detecting an incoming individual to create user input data;
storing data in an authorized individual database for individuals that are authorized users that are authorized for entry into the building;
comparing the user input data of the incoming individual to the authorized individual database and providing an authorized signal if the user input data for the incoming individual is recognized in the authorized individual database;
activating a lock release signal to unlock a door to allow entry into the building, responsive to the authorized signal.

16. The method for automating security and entry as in claim 15,
wherein there is from one to multiple cameras used to capture an image of the entrant to generate the entrant data for said individual for comparison to the authorized individual database.

17. The method for automating security and entry as in claim 16,
wherein the cameras are fitted with a sensor that will be able to detect at least one of motion, thermal energy, and sound disturbances,
wherein the camera is activated when the disturbance is detected.

18. The method for automating security and entry as in claim 15,
wherein one of the individuals authorized for entry is a primary user having a primary user's account that defines which individuals are authorized for entry;
the method further comprising:
adding new user input data to the primary user's account, for a new approved user as an individual authorized for entry, so that thereafter the new approved user be able to use the method to provide approval for entry and will provide for opening of the door.

19. The method for automating security and entry as in claim 15, the method further comprising:
scanning a fingerprint of said incoming individual,
wherein the scanned fingerprint of the incoming individual is compared to the entrant data in the authorized individual database to see if the fingerprint is recognized, and if it is then a signal is sent to open the door.

20. The method for automating security and entry as in claim 15, the method further comprising:
entering a user input code by said incoming individual,
wherein there are authorized preset codes for at least some of the authorized users, and
wherein the user input code of the incoming individual is compared to the authorized preset codes to see if the user input code is recognized, and if it is then a signal is sent to open the door.

21. The method for automating security and entry as in claim 15,
wherein a tone is played when said incoming individual is approved for entry as an alert that the door is opening.

22. The method for automating security and entry as in claim 15,
wherein a loud, aggressive alert tone is played when there is one of an attempt at unauthorized opening of the door and actual forceful unauthorized opening of the door.

23. The method for automating security and entry as in claim 15,
wherein at least one person is a primary user with a phone,
wherein an alert to the primary user's phone when there is one of an attempt at unauthorized opening of the door and actual forceful unauthorized opening of the door.

24. The method for automating security and entry as in claim 15, the method further comprising:
backing up power from battery packs that have lights to indicate when the power of the battery packs power is getting close to empty.

25. The method for automating security and entry as in claim 15,
wherein the authorized database also contains authorized voice samples for at least some of the authorized users,
the method further comprising:
sensing voice sound spoken by said incoming individual,
wherein the user voice sensed of the incoming individual is compared to the authorized voice samples in the authorized individual database to see if the user voice sensed of the incoming individual is recognized, and if it is then a signal is sent to open the door.

26. The method for automating security and entry as in claim 15, further comprising:
providing a deadbolt that when engaged adds a physical lock to the door, and ensures that the door cannot be opened by the system.

27. The method for automating security and entry as in claim 15, further comprising:
providing a speaker outside the door, and,
providing an interface for the primary user to utilize a phone to communicate audio out of the speaker.

28. The method for automating security and entry as in claim 15, further comprising:
sensing that the door has been left open beyond a defined time limit, and responsive thereto, providing for closing of the door.
